(19) United States
(12) Patent Application Publication
(10) Pub. No.: US 2015/0087183 A1
(43) Pub. Date: Mar. 26, 2015

(54) CONNECTOR TERMINAL HOUSING

(71) Applicant: YAZAKI CORPORATION, Tokyo (JP)

(72) Inventor: Nobuyuki SAKAMOTO, Makinohara-shi (JP)

(21) Appl. No.: 14/558,812

(22) Filed: Dec. 3, 2014

Related U.S. Application Data
(63) Continuation of application No. PCT/JP2013/003118, filed on May 16, 2013.

(30) Foreign Application Priority Data
Jun. 15, 2012 (JP) 2012-135557

(51) Int. Cl. H01R 13/74

(52) U.S. Cl. CPC H01R 13/74
USPC 439/553

(57) ABSTRACT

A connector terminal housing includes a housing hole for a connector terminal to be housed, and a biasing portion provided in the housing hole and configured to bias the connector terminal housed in the housing hole to eliminate rattle of the connector terminal housed in the housing hole. A thickness of a portion other than a base end of the biasing portion is equal to or smaller than a thickness of the base end.

### CROSS REFERENCE TO RELATED APPLICATION

This application is a Continuation of PCT Application No. PCT/JP2013/003118, filed on May 16, 2013, and claims the priority of Japanese Patent Application No. 2012-135557, filed on Jun. 15, 2012, the content of both of which is incorporated herein by reference.

### BACKGROUND

1. Technical Field

The present invention relates to a connector terminal housing, and more particularly, to a connector terminal housing capable of housing a connector terminal without rattle.

2. Related Art

JP 2007-87810 A discloses a technique of installing a connector terminal in each end of a plurality of electric wires and connecting the connector terminals to each other to obtain a conduction path between each electric wire.

In some cases, each connector terminal is housed in a connector terminal housing to connect the electric wires to each other as described above.

### SUMMARY

In a case where each connector terminal is housed in a connector terminal housing to connect the electric wires to each other as described above, it is necessary to improve reliability between contacts of each connector terminal (for obtaining a reliable conduction path).

For this necessity, a motion of each connector terminal is suppressed by biasing the connector terminal housed in the connector terminal housing into a predetermined direction. That is, rattle of the connector terminal housed in the connector terminal housing against the connector terminal housing is eliminated.

Specifically, as illustrated in FIG. 1 or 2, rattle is eliminated by biasing the connector terminal into a predetermined direction (pressing into the right side in FIG. 1 or 2) using a biasing portion (spring portion) 205 when each connector terminal (not illustrated in FIG. 1 or 2) is inserted into each housing hole 203 of the connector terminal housing 201. In FIGS. 1 and 2, a vertical direction on the paper plane indicates a longitudinal direction LD, and a horizontal direction on the paper plane indicates a transverse direction TD.

As the connector terminal moves relatively to the connector terminal housing 201 in a direction perpendicular to the paper plane of FIG. 1 or 2, the connector terminal is housed in the housing hole 203 of the connector terminal housing 201 or is extracted from the housing hole 203.

The biasing portion 205 is provided in one side of the housing hole 203 (for example, a wall 207 partitioning the neighboring housing holes 203). The biasing portion 205 illustrated in FIG. 1 or 2 has a pentagonal shape obtained by chamfering one corner of a rectangle. The biasing portion 205 has a three-dimensional shape extending by a predetermined length in a direction perpendicular to the paper plane of FIG. 1 or 2 while the shape of FIG. 1 or 2 is maintained.

When the connector terminal in the connector terminal housing 201 is provided by inserting the connector terminal into the housing hole 203, the biasing portion 205 is elastically deformed as indicated by the two-dotted chain line of FIG. 2. By virtue of a reaction of this elastic deformation, the connector terminal is pressed into the right direction of FIG. 2 so as to eliminate the rattle.

However, although the biasing portion 205 is elastically deformed in cantilever fashion to bias the connector terminal housed in the housing hole 203, the shape of the biasing portion 205 has an unuseful portion.

Specifically, since the biasing portion 205 has a chamfered shape, the lower thickness W5b is larger than the upper thickness W5a (upper horizontal dimension of the biasing portion 205 in FIG. 2). However, if the lower thickness W5b is set to be larger in a case where elastic deformation occurs in cantilever fashion as illustrated in FIG. 2, such a shape is entirely meaningless. Since the lower thickness W5b is set to be larger, an unuseful material is generated.

It is therefore an object of this invention to provide a connector terminal housing capable of eliminating unusefulness as much as possible in the basing portion of the connector terminal housing where the connector terminal is housed.

A connector terminal housing in accordance with some embodiments includes: a housing hole for a connector terminal to be housed; and a biasing portion provided in the housing hole and configured to bias the connector terminal housed in the housing hole to eliminate rattle of the connector terminal housed in the housing hole. A thickness of a portion other than a base end of the biasing portion is equal to or smaller than a thickness of the base end.

The housing hole may be provided in a plurality. The housing holes may be arranged in a predetermined direction at a predetermined interval. The biasing portion may be provided in a partition wall placed between neighboring housing holes out of the housing holes. A thickness of the biasing portion may be equal to or slightly smaller than a thickness of the partition wall.

In this configuration, it is possible to eliminate unusefulness in the biasing portion of the connector terminal housing where the connector terminal is housed.

### BRIEF DESCRIPTION OF DRAWINGS

FIG. 1 is a cross-sectional view illustrating a related connector terminal housing and a view corresponding to FIG. 4.

FIG. 2 is an enlarged view of the II-portion in FIG. 1.

FIG. 3 is a perspective view illustrating schematic configurations of the connector terminal housing according to an embodiment of the invention and the connector terminal housed in the connector terminal housing.

FIG. 4 is a cross-sectional view taken along a line IV-IV in FIG. 3 obtained by cutting the connector terminal housing according to an embodiment of the invention on a plane (plane perpendicular to a front-rear direction) for development in longitudinal and transverse directions.

FIG. 5 is an enlarged view of the V-portion in FIG. 4.

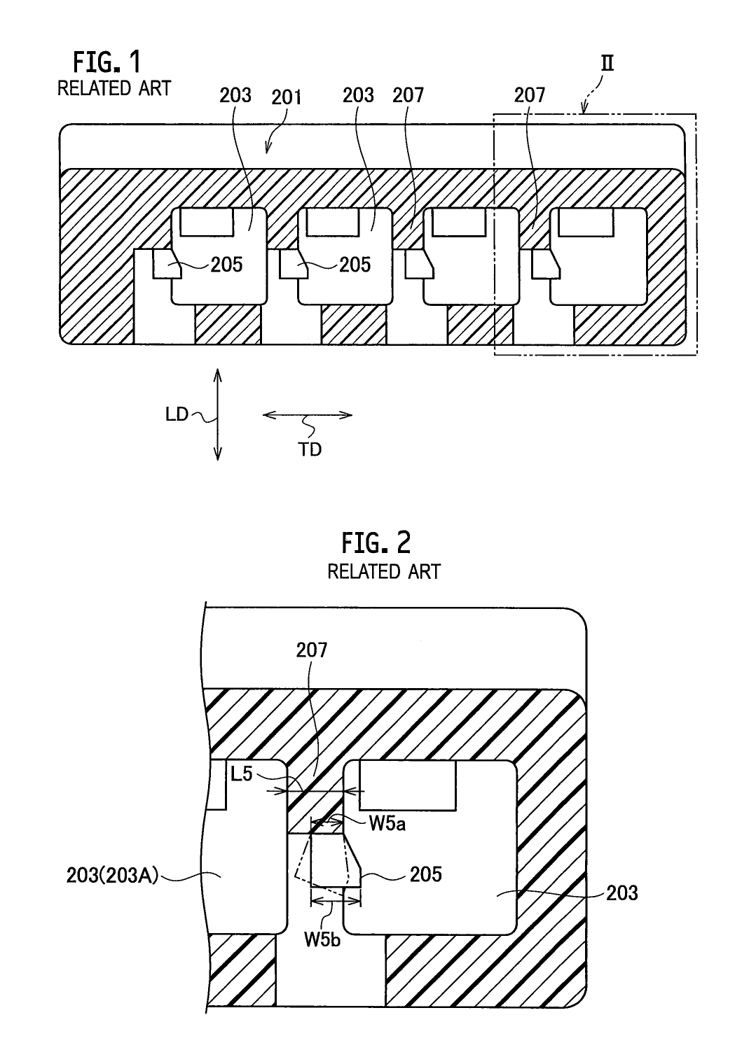

### DETAILED DESCRIPTION

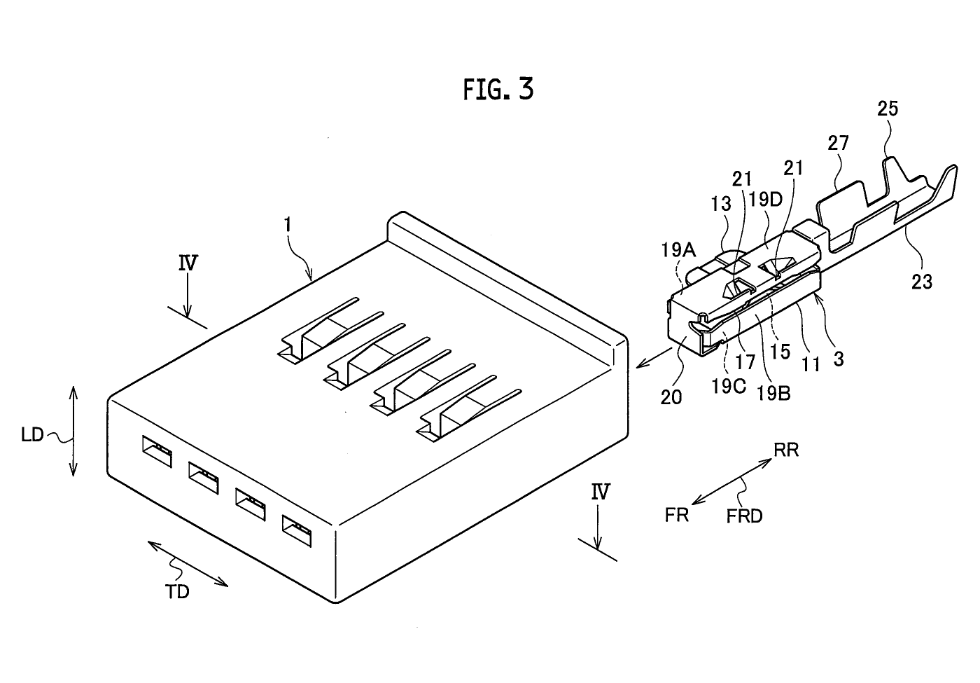

Hereinafter, a connector terminal housing 1 according to an embodiment of the invention will be described in detail with reference to FIGS. 3 to 5. As illustrated in FIG. 3, a connector terminal 3, for example, made of metal is inserted into and housed in the connector terminal housing 1. The connector terminal housing 1 is made of an electrically insulative synthetic resin.

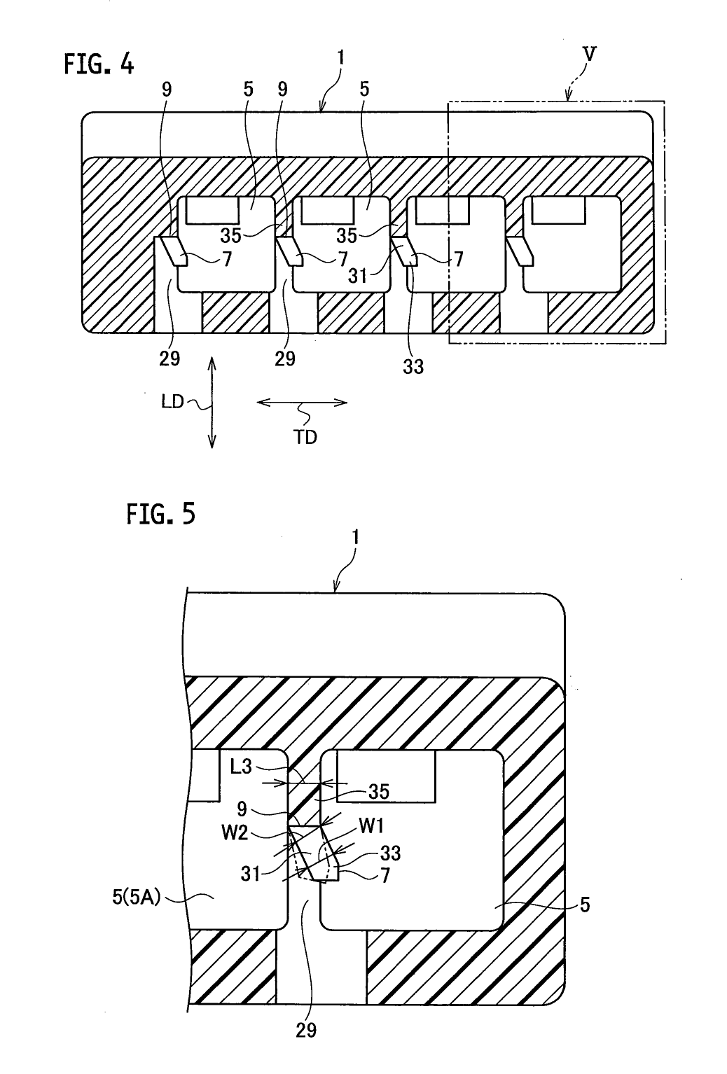

As illustrated in FIG. 4, the connector terminal housing 1 includes a housing hole (connector terminal housing hole) 5 and a biasing portion (spring portion) 7.

The housing hole 5 is configured to house the connector terminal 3 and is formed, for example, in a rectangular pillar shape.

The biasing portion 7 is provided in the housing hole 5. The biasing portion 7 biases the connector terminal 3 housed in the housing hole 5 into a predetermined direction to eliminate rattle of the connector terminal 3 housed in the housing hole 5 against the connector terminal housing 1.

As illustrated in FIG. 5, in the biasing portion 7, a thickness W2 of a base end 9 is equal to a thickness W1 of a portion other than the base end 9 (any portion other than the base end). Alternatively, the thickness W1 may be smaller than the thickness W2.

The connector terminal 3 is manufactured, for example, by molding a flat metallic material in a predetermined shape and bending the material molded in the predetermined shape.

Here, for convenient description purposes, a length direction of the connector terminal 3 or the housing hole 5 of the connector terminal housing 1 is denoted by a front-rear direction FRD. In addition, the front side of the front-rear direction FRD is denoted by FR, and the rear side of the front-rear direction FRD is denoted by RR. In addition, a direction perpendicular to the front-rear direction FRD is denoted by a transverse direction TD, and a direction perpendicular to the transverse direction TD and the front-rear direction FRD is denoted by a longitudinal direction LD.

As illustrated in FIG. 3, the connector terminal 3 generally has a rectangular pillar appearance. As the connector terminal 3 moves forward from a state that the connector terminal housing 1 is placed in the front side FR of the front-rear direction FRD of the connector terminal 3 (more specifically, the connector terminal housing 1 is separated from the connector terminal 3 and maintains a predetermined appropriate posture in a predetermined appropriate position), the connector terminal 3 is inserted into and housed in the housing hole 5 of the connector terminal housing 1 so that the connector terminal 3 is integrally installed in the connector terminal housing 1.

The connector terminal 3 includes a main body 11, a male contact portion (male terminal portion) 13, a female contact portion (female terminal portion) 15, and a slit (side slit) 17.

The main body 11 is formed in a rectangular tubular shape. The rectangular tubular main body 11 has four side walls (first, second, third, and fourth side walls 19A, 19B, 19C, and 19D, respectively) formed in a rectangular flat plate shape. The front end of the main body 11 is blocked by a front wall 20 in order to improve rigidity of the connector terminal 3.

The first side wall 19A is arranged in one side of the main body 11 in a transverse direction TD. The second side wall 19B faces the first side wall 19A and is arranged in the other side of the main body 11 in a transverse direction TD. The third side wall 19C is arranged in one side of the main body 11 in a longitudinal direction LD. The fourth side wall 19D faces the third side wall 19C and is arranged in the other side of the main body 11 in a longitudinal direction LD.

The male contact portion 13 protrudes from the first side wall 19A of the main body 11 to one side of the transverse direction TD. The male contact portion 13 is formed, for example, in a flat plate shape, and the thickness direction of the male contact portion 13 is set to the longitudinal direction LD. The male contact portion 13 is located in the center of the main body 11 in a longitudinal direction LD and is also located in the center of the main body 11 in the front-rear direction FRD. A dimension of the male contact portion 13 in the front-rear direction FRD is smaller than a dimension of the main body 11 in the front-rear direction FRD.

The female contact portion 15 is provided inside the main body 11. The female contact portion 15 includes an abutting portion 21 and a spring portion (not illustrated). The abutting portion 21 is formed to protrude inward from the third side wall 19C in the main body 11. The spring portion is formed to protrude inward from the fourth side wall 19D in the main body 11. The abutting portion 21 is arranged in one side of the longitudinal direction LD, and the spring portion is arranged in the other side in the longitudinal direction LD.

The slit 17 is provided in the second side wall 19B of the main body 11. The slit 17 is arranged in the center of the main body 11 in the longitudinal direction LD and penetrates the main body 11 (second side wall 19B) in the front-rear direction FRD. Since the slit 17 is formed, the second side wall 19B is divided into two parts.

Specifically, it is assumed here that the main body 11 has a tubular shape for convenient description purposes although, strictly to say, it does not have a tubular shape since the slit 17 is provided. In addition, the width of the slit 17 (dimension in the longitudinal direction LD) increases in the vicinity of both ends of the front-rear direction FRD to form a taper shape. The width of the slit 17 in the center of the front-rear direction FRD is larger than the thickness of the male contact portion 13 (dimension in the longitudinal direction LD). The slit 17 is arranged in the same position as that of the male contact portion 13 in the longitudinal direction LD. That is, the center position of the slit 17 in the longitudinal direction LD matches the center position of the male contact portion 13 in the longitudinal direction LD.

The connector terminal 3 is provided with an electric wire connecting portion 23. The electric wire connecting portion 23 protrudes from the main body 11 to the rear direction RR in the rear side RR of the main body 11.

The electric wire connecting portion 23 includes a conductor holding portion 25 that holds a conductor (conductor of the electric wire) exposed by stripping a cover and a cover holding portion 27 that holds a part of the cover of the electric wire. The conductor holding portion 25 and the cover holding portion 27 are crimped so that they are integrally installed in an end of the electric wire (not illustrated) to hold the electric wire.

The housing hole 5 of the connector terminal housing 1 is provided with a biasing portion formation portion 29 as illustrated in FIGS. 4 and 5. The biasing portion formation portion 29 is formed in a through-hole or a concave portion provided in a part of the surface (inner surface) in the housing hole 5 and is linked to the housing hole 5. The concave portion or the through-hole is shaped to increase a volume of the housing hole 5 formed in a rectangular pillar shape. The biasing portion 7 protrudes from a part of the surface of the biasing portion formation portion 29. Specifically, the biasing portion 7 protrudes from a surface of one end side of the longitudinal direction LD to the other end side of the longitudinal direction LD. In FIGS. 4 and 5, the biasing portion 7 is inclined from the upper side and protrudes toward the lower right direction.

Therefore, a portion other than the base end 9 of the biasing portion 7 is separated from the surface of the biasing portion formation portion 29. Accordingly, elastic deformation occurs as described below.

While the connector terminal 3 is not housed in the housing hole 5, a portion 31 in the base end side (base end portion) of the biasing portion 7 is placed inside the biasing portion formation portion 29 as illustrated in FIGS. 4 and 5. On the other hand, a portion 33 in the leading end side (leading end portion: portion other than the base end) of the biasing portion 7 protrudes from the biasing portion formation portion 29 to the inside of the housing hole 5.

When the connector terminal 3 is housed in the housing hole 5, the biasing portion 7 is elastically deformed toward the biasing portion formation portion 29 (left side in FIG. 5) as indicated by the two-dotted chain line of FIG. 5. By virtue of a reaction of this elastic deformation, the connector terminal 3 is biased to the side (right side in FIGS. 4 and 5) opposite to the biasing portion formation portion 29 (biasing portion 7).

In FIG. 4 or 5, the connector terminal 3 is not illustrated intentionally. In addition, the thickness of the biasing portion 7 is a dimension of the biasing portion 7 (W1 and W3 in FIG. 5) in a direction approximately parallel to the elastic deformation direction of the biasing portion 7 described above (slightly inclined to the transverse direction TD).

As illustrated in FIG. 3 or 4, a plurality of housing holes 5 is provided in the connector terminal housing 1. Such housing holes 5 are arranged in a predetermined direction (transverse direction TD) at a predetermined interval.

The biasing portion formation portion 29 and the biasing portion 7 are provided, for example, in any part of the partition wall 35 placed between each of the neighboring housing holes 5 with a predetermined thickness. The thicknesses W1 and W2 of the biasing portion 7 are set to be equal to or slightly smaller than the thickness L3 of the partition wall 35. Note that, the thickness of the biasing portion 7 may be gradually reduced from the base end 9 to the leading end (from the top to the bottom in FIGS. 4 and 5). In this case, the thickness of the biasing portion 7 in the base end 9 is equal to or slightly smaller than the thickness L3 of the partition wall 35.

Since a plurality of housing holes 5 is provided, a plurality of connector terminals 3 is simultaneously installed in a single connector terminal housing 1 in parallel with the transverse direction TD. The connector terminals 3 installed in this way are engaged with each other and are electrically conducted to each other (by making contact with each other). In addition, the neighboring connector terminals 3 installed in the connector terminal housing 1 in parallel with the transverse direction TD make contact with each other and are electrically conducted to each other.

Specifically, when a plurality of connector terminals 3 is simultaneously installed in a single connector terminal housing 1 in parallel with the transverse direction TD, the male contact portion 13 of one of the neighboring connector terminals 3 is engaged with the female contact portion 15 of the other connector terminal 3 to electrically conduct the neighboring connector terminals 3 to each other.

That is, the male contact portion 13 of one of the connector terminals 3 is nipped between the abutting portion 21 and the spring portion of the female contact portion 15 of the other connector terminal 3 by virtue of a biasing force of the spring portion, so that the male contact portion 13 of one of the connector terminals 3 is reliably engaged with the female contact portion 15 of the other connector terminal 3.

When a plurality of connector terminals 3 is simultaneously installed in a single connector terminal housing 1 in parallel with the transverse direction TD, the male contact portion 13 of a single connector terminal 3 provided in one end of the transverse direction TD, since no connector terminal 3 exists in the vicinity thereof, is not engaged with the female contact portion 15.

When a plurality of connector terminals 3 is simultaneously installed in a single connector terminal housing 1 in parallel with the transverse direction TD, the female contact portion 15 of a single connector terminal 3 provided in the other end of the transverse direction TD, since no connector terminal 3 exists in the vicinity thereof, is not engaged with the male contact portion 13.

If a plurality of connector terminals 3 is simultaneously installed in a single connector terminal housing 1 in parallel with the transverse direction TD, the male contact portion 13 of the connector terminal 3 is engaged with the female contact portion 15 of the connector terminal 3 installed in the neighboring housing hole 5 through a through-hole (not illustrated) provided in the partition wall 35.

In the connector terminal housing 1, the thicknesses W1 and W2 of the biasing portion 7 are nearly constant. Therefore, unusefulness in a material of the biasing portion 7 is substantially eliminated.

Since the thicknesses W1 and W2 of the biasing portion 7 are nearly constant, it is possible to avoid a stress generated by biasing the connector terminal 3 housed in the housing hole 5 in cantilever fashion from being concentrated on the base end side of the biasing portion 7.

In the connector terminal housing 1, the thicknesses W1 and W2 of the biasing portion 7 are constant and equal to or slightly smaller than the width L3 of the partition wall 35. Therefore, it is possible to reduce a pitch of the housing hole 5 (pitch in the transverse direction TD in FIG. 4) and miniaturize the connector terminal housing 1.

That is, if the biasing portion 205 has a pentagonal shape as disclosed in the related art (refer to FIG. 2), it is necessary to increase a dimension L5 of the wall 207. That is, when the dimension L5 of the wall 207 is set to be large, and the biasing portion 205 is elastically deformed as indicated by the two-dotted chain line, it is necessary to prevent a rear face of the biasing portion 205 (portion opposite to the side where the connector terminal housed in the housing hole 203 makes contact) from protruding into the inside of the housing hole 203A illustrated in the left side of FIG. 2.

In contrast, in the connector terminal housing 1 according to the present embodiment, the thicknesses W1 and W2 of the biasing portion 7 are constant and equal to or slightly smaller than the thickness L3 of the partition wall 35. Therefore, even when the thickness L3 of the partition wall 35 is thinned (that is, the pitch of the housing hole 5 is reduced), it is possible to prevent the rear face of the biasing portion 7 from protruding to the inside of the housing hole 5A in the left side of FIG. 5 as illustrated in FIG. 5. In addition, it is possible to prevent interference between the rear face of the biasing portion 7 and the connector terminal 3 and miniaturize the connector terminal housing 1.

In the connector terminal housing 1, rattle of the connector terminal 3 housed in each housing hole 5 against the connector terminal housing 1 is eliminated. Therefore, it is possible to improve reliability in engagement between the contacts of each connector terminal 3.

Although the present invention has been described above by reference to the embodiments and the example, the present invention is not limited to those, and it will be apparent to these skilled in the art that various modifications and improvements can be made.

What is claimed is:

1. A connector terminal housing comprising:
a housing hole for a connector terminal to be housed; and
a biasing portion provided in the housing hole and configured to bias the connector terminal housed in the housing hole to eliminate rattle of the connector terminal housed in the housing hole, a thickness of a portion other than a base end of the biasing portion being equal to or smaller than a thickness of the base end,
wherein the biasing portion is configured to be elastically deformed with reference to an axis along an insertion direction of the connector terminal into the housing hole.

2. The connector terminal housing according to claim 1, wherein
the housing hole is provided in a plurality,
the housing holes are arranged in a predetermined direction at a predetermined interval,
the biasing portion is provided in a partition wall placed between neighboring housing holes out of the housing holes, and
a thickness of the biasing portion is equal to or slightly smaller than a thickness of the partition wall.
